(19) United States
(12) Patent Application Publication
(10) Pub. No.: US 2026/0123643 A1
(43) Pub. Date: May 7, 2026

(54) PLANT-BASED CHEESE OF THE HALF-HARD TYPE

(71) Applicant: Flora Food Global Principal B.V., Amsterdam (NL)

(72) Inventor: Jochen EFFEY, Amsterdam (NL)

(21) Appl. No.: 19/117,947

(22) PCT Filed: Oct. 5, 2023
(86) PCT No.: PCT/EP2023/077522

§ 371 Date: Apr. 2, 2025

(30) Foreign Application Priority Data
Oct. 7, 2022 (EP) 22200213.1

(51) Int. Cl. A23C 20/02

(52) U.S. Cl. CPC A23C 20/025; A23C 2240/15

(57) ABSTRACT

The invention provides a plant-based cheese of the half-hard type comprising from 5 to 35 wt. % of a vegetable fat, from 20 to 40 wt. % (modified) starches; from 1 to 7 wt. % (phospholipid) w/o emulsifier, the remainder (up to 100 wt. %) being water, wherein the wt. % are calculated on the total composition, and a method for its preparation.

### FIELD OF THE INVENTION

The invention relates to a plant-based cheese of the half hard type and a method for its preparation.

### BACKGROUND OF THE INVENTION

Cheese is a much admired asset to many tables and taste. Conventional cheese is made from dairy. With the enhanced interest in vegetarian and plant-based (or plant-based) products, and more in general plant-based products, a plant-based alternative that can pair the mouthfeel, texture and taste of a classic cheese of the half-hard type such as a Gouda, Edam, or Emmentaler cheese is considered highly desirable. Examples of plant-based cheeses of the half-hard type are described in US20220287320, EP4066648 and US20190000103.

Traditional cheese production has always been carried out using the animal milk as a basic ingredient. In recent years, there has been a significant increase in demand for cheese generally, as well as for cheeses with specific performance or nutritional characteristics. This general demand is driven in part by the steady growth in the ready meal or convenience food sector of the food industry since cheese is an ingredient in many foods within this sector. The increasing popularity of various pizza-type products is one specific example of cheese-containing products in this sector that have contributed to the surge in demand. These concerns, as well as cost considerations, have been the impetus for the development of a number of analogue cheeses (e.g., imitation cheeses or cheese substitutes) that offer various health advantages (e.g., replacement of animal fat with healthier vegetable oil and increased vitamin or mineral levels) and cost benefits (e.g., vegetable oils are less expensive than certain dairy ingredients).

Analogue cheeses constitute a major category of cheese. As alluded to above, there has been an increased demand for analogue cheese because of cost and health considerations. Analogue cheese generally refers to a cheese in which milk fat and/or a protein source has been substituted with a source that is not native to milk. Analogue cheeses are typically lower cost than other cheese types because the processing can be performed less expensively and because certain milk ingredients can be substituted with cost effective food ingredients (e.g., substituting vegetable oil for milk fat). The health benefits derive from substitution of the milk fat and protein with other healthier substitutes and the ability to add other ingredients that can improve the nutritional characteristics of the final product.

Analogue cheeses (or substitute cheeses) are typically categorized as dairy, partial dairy, or non-dairy, depending on whether the fat and/or dairy components are from dairy or vegetable sources. They can also be classified as being an imitation cheese or a substitute cheese. Imitation cheese is a substitute for and resembles another cheese but is nutritionally inferior to that cheese. A cheese substitute, on the other hand, resembles another cheese but is not nutritionally inferior to that cheese.

However, replacing conventional cheese composition ingredients can present technical hurdles because cheese compositions are complex and their properties can be sensitive to modified or inherent functional characteristics associated with micro and macro structures of these ingredients. Thus, conventional cheese manufacturing has come to rely on certain cheese composition ingredients to provide certain properties. Exemplary technical challenges include finding substitute ingredients that provide cheese compositions with one or more suitable functional properties (e.g., melt, stretch, and firmness), organoleptic properties (e.g., texture and flavor), and when necessary, nutritional properties.

Conventional manufacturers include three key components in cheese analogues, namely a dry ingredient blend, water, and fats. Dry ingredient blends may contain combinations of ingredients such as starches, stabilizers, dairy and non-dairy proteins, emulsifying salts, emulsifiers, pH adjusters, fibers, colorants, and flavors.

In first generation cheese analogues, inclusion of dairy proteins was crucial in achieving the desirable melt and stretch of similar to that of natural cheese products.

In recent years, the spread of greater ecological awareness combined with the increasingly widespread feeling of empathy towards animal sufferings, as well as the search for a healthier diet, therefore without animal fats, has seen to reach on the market and to obtain the satisfaction of consumers of different vegetable, vegetarian or plant-based alternatives to the classic cheese. These alternatives, however, are often characterized by a different structure, which may give them a different appearance, and by the lack of organoleptic qualities, to the point of not making them in any way comparable to traditional cheeses either in taste, color or in texture i.e. in structure, or in appearance.

The few existing proposals concerning to the imitation of hard and aged cheeses are made with formulas and processes that fail to obtain appreciable results in terms of structure (texture) and shelling of the product when it is broken by hand, with a knife or with machineries, with the result of not being comparable, in aspect and in behaviour when cut, to the original traditional product of animal milk based, because they are more rubbery, oily or floury, and in no case really attributable to the original dairy product.

Cheese of the half-hard type or medium-hard cheese generally range in texture from semi-soft to firm include Swiss-style cheeses such as Emmental and Gruyère. Other semi-soft to firm cheeses include Gouda, Edam, Jarlsberg, Cantal, and Kashkaval/Cascaval. These cheese are all dairy based. Cheeses of this type are ideal for melting and are often served on toast for quick snacks or simple meals.

Plant-based cheese have been described for instance in US2020232231 and comprise gelling agents such as gellan to provide for the desired compressibility while avoiding rupture. Exemplary formulations contain water, pea protein coconut oil, potato starch, gellan gum and sunflower oil too imitate mozzarella. Low amounts of emulsifiers such as lecithins can be used.

EP3884770 describes a plant based substitute of a hard or plastic cheese such as hard (and aged) cheeses such as Parmesan, Grana, Pecorino, Scamorza, Caciocavallo. The focus lies on the provision of a granular and fibrous, flake structure which is achieved by a combination of wheat starch and/or potato flakes in combination with fat components and water to which plant proteins may be added.

There is a need for non-dairy containing cheeses of the half hard type that combine a mouthfeel and a melting profile that is described in Dutch as “smedig”: a soft mouthfeel, that is not experienced as dry or lumpy.

### SUMMARY OF THE INVENTION

The present inventors found that a cheese alternative based on a combination of vegetable fat, (modified) starches and a relative high amount of phospholipid w/o emulsifier having a HLB of <7 resulted in a cheese with an excellent taste, texture and mouthfeel.

Thus in a first aspect the invention pertains to a plant-based cheese of the half-hard type comprising
5-35 wt. % of a vegetable fat;
20-40 wt. % (modified) starches;
1-7 wt. % (phospholipid) w/o emulsifier having a HLB of <7;
the remainder (up to 100 wt. %) being water, wt. % calculated on the total composition.

Thus in a further aspect, the invention pertains to a method of preparing a plant-based cheese analogue composition comprising the steps of:
mixing starches, optional proteins, phospholipid w/o emulsifier having a HLB of <7, fat and water
providing a homogenous mixture from the mixed ingredients by mixing under shear to form an emulsion;
providing a plant-based cheese analogue.

### DETAILED DESCRIPTION OF THE INVENTION

Thus in a first aspect, the invention pertains to a plant-based cheese of the half-hard type comprising
5-35 wt. % of a vegetable fat;
20-40 wt. % (modified) starches;
1-5 wt. % phospholipid w/o emulsifier having a HLB of <7;
the remainder (up to 100 wt. %) being water, wt. % calculated on the total composition.

The plant-based cheese of the present invention has a good (aka smooth, “smedig”) mouthfeel and does not stick/adhere to teeth.

The invention provides vegetable cheeses without any use of gluten, and thus allowing to obtain vegetable gluten-free cheeses. Furthermore, the vegetable cheeses do not contain any ingredients of animal origin and qualify as plant-based. The invention is based on the use of staple ingredients that are simple and economical and can be prepared by a simple and fast preparation process, making it particularly advantageous for applications on a large industrial scale. The cheese analogues of the invention may be formed into products similar to natural and analogue cheese types, such as, but not limited to, mozzarella, cheddar, Gouda, and pizza cheese. The end products has several technical advantages over their existing dairy and non-dairy based counterparts, including extended shelf-life, resistance to separation when cooked, and uniformity of product. Its production also enjoys significant economic advantages over traditional cheese-making processes, most often through the ability to incorporate any of a wide variety of less expensive ingredients.

### Fats

The fat phase can be any vegetable fat. The fat phase may contain coconut, rapeseed, sunflower, palm, shea, soy, cocoa, allan blackia fats. The fat phase from these sources may contain interesterified fats, fractionated fats or combinations of both. There is a preference for coconut fat and/or coconut fat fractions. Preferably, the vegetable fat is a non-hydrogenated fat and/or does not contain palm-oil of palm-oil derived fats or fractions thereof.

### Phospholipid w/o Emulsifier Having a HLB of <7

In the plant-based cheese of the invention emulsifiers are used that are preferably w/o emulsifiers having a HLB of <7. Such emulsifiers are preferably phospholipid-containing (w/o) emulsifiers. The phospholipid w/o emulsifier having a HLB of <7 of the invention is typically and preferably a lecithin or phospholipid-containing lecithin fractions, isolate or concentrate of lecithin. Lecithin as a natural product typically contains about 65-75% phospholipids supplemented with triglycerides and smaller amounts of other substances. The major phospholipids in lecithin include phosphatidylcholine (PC), phosphatidylethanolamine (PE), and inositol-containing phosphatides (PI).

Lecithin, in embodiments of the present invention, may be a lecithin from marine sources, or vegetable sources. The lecithin is preferable a vegetable lecithin (non-dairy, non-marine). The lecithin may be natural (or native) and/or fractionated. There is a preference for natural (or native) lecithin or fractions of lecithin. The lecithin can be selected from the group consisting of sunflower, soy, rapeseed, cottonseed, and combinations thereof. There is a preference for sunflower lecithin and/or soy lecithin. There is a preference for natural (or native) sunflower and/or soy lecithin. The amount of lecithin is between 1 and 5 wt. %, preferably between 3 and 4.5 wt. %. Alternative preferred amounts of lecithin are more than 1 wt. %, more than 1.5 wt. %, more than 2 wt. %, more than 2.5 wt. %, more than 3 wt. %, optionally combined with less than 10 wt. %, 9 wt. %, 8 wt. %, 7 wt. %, 6% wt. % of lecithin. The lecithin used is preferably not de-oiled and hence can contain triglycerides. In alternative embodiments, the lecithin can be a de-oiled lecithin, a lecithin from which (part of) the triglycerides are removed and are hence more concentrated in phospholipids. There is a preference for lipophilic lecithins. Hydrolysed, hydroxylated and/or hydrophilic lecithins are less preferred. There is a preference for w/o emulgating lecithins. There is a preference for lecithins having a HLB value below 7, preferably between 2 and 6, such as PI-F (enriched) lecithin fractions, PE-F (enriched) lecithin fractions, and, preferably lecithin depleted in PC.

The lecithin used in the plant-based cheese of the invention is in an amount that exceeds conventional use of lecithin as an emulsifier in (plant-based) cheese. Conventional use of lecithin in (plant-based) cheese is typically below 1 wt. %. Conventional plant-based cheeses are often qualified as clumpy and having a brittle mouthfeel. The use of the lecithins and in these amounts improves the melting behaviour and mouthfeel of the plant-based cheese of the invention that leads to a cheese that is regarded as having improved organoleptic properties.

### Starches

The plant-based cheese of the invention further comprises starches and a number of different types of starches can be incorporated into cheese. Suitable starches include vegetable starches (e.g., potato starch, arrowroot starch, pea starch, and tapioca) and grain starches (e.g., corn starch, wheat starch, and rice starch). Specific examples of suitable corn starches include dent corn starch, waxy corn or maize starch, and high amylose corn starch. The starches can be used individually or in combination. As noted above, starches can advantageously be included in the slurry. In some applications, the starch is added as a powder or unheated solution. The starch can be waxy, modified or native. Modified starches, also called starch derivatives, are prepared by physically, enzymatically, or chemically treating native starch, thereby changing the properties of the starch. Modified starches are used in practically all starch applications, such as in food products as a thickening agent, stabilizer or emulsifier. Modified food starches differ in their degree of cross-linking, type of chemical replacement, oxidation level, degree of molecular scission, and ratio of amylose to amylopectin.

In the present invention, the starches are selected form the group consisting of modified and unmodified starches, preferably modified starches. There is a preference for starches that are selected from the group consisting of wheat starch, corn starch, potato starch, rice starch, tapioca starch, and any combination thereof.

In preferred embodiments of the invention, there is a preference for modified tapioca starch. Modified tapioca starch can be present in an amount of 8-12 wt. %, preferably from 9 to 11 wt. % calculated on the total composition. Tapioca starch, as formulated according to the present invention, has a relatively high viscosity, excellent water-holding capacity and binding ability. It is bland and clean in flavor. Once heated it forms a clear gel exhibiting a long and slightly stingy texture. Upon cooling, it sets to a soft gel. Once cooked, the gel resembles that of a potato but with less stringy texture and a more neutral flavor, suitable for use as a thickener. Tapioca starch, further provided the desired moisture retention and cell size. In preferred embodiments of the invention, there is a preference for modified potato starch. Modified potato starch can be present in an amount of 8-12 wt. %, preferably from 9 to 11 wt. % calculated on the total composition. In preferred embodiments of the invention, there is a preference for modified corn starch. Modified corn starch can be present in an amount of 5-9 wt. %, preferably from 6 to 8 wt. % calculated on the total composition. There is a preference for a combination of two or more, preferably all three starches of the preferred embodiments of the invention. The starches can be combined in a ratio (w/w) of from 20:20:60 to 40:40:20.

### Plant Protein

The plant-based cheese of the invention preferably further comprises a plant protein or plant protein isolate or plant protein concentrate. The vegetable protein concentrate may include one or more of pea protein, fava (Vicia faba) protein, amaranth protein, chickpea protein, lima beans protein, lentil protein; and any other suitable vegetable protein; or combinations thereof. In an embodiment, the protein concentrate does not include any or substantially any soy bean protein to minimize allergenic reactions. A plant protein or plant protein isolate or concentrate can be present in an amount from 0.1 to 11 wt. %, preferably from 2 to 10, more preferably from 3 to 8 wt. %, calculated on the total composition. In preferred embodiments, the plant protein is selected from the group consisting of lentil protein, fava (Vicia faba) protein and pea protein or combinations thereof. The presence of a plant protein as outlined herein, provides additional textural advantages to the plant-based cheese and improves stability, attributed to the emulsifying properties of the plant protein.

### Other Ingredients

The plant-based cheese of the invention may further contain stabilizers. Stabilizers improve the textural quality of foods. It can impart a rich mouth feel without masking flavor, enhances moisture retention, prevents syneresis. Examples of suitable gums that can be incorporated include, but are not limited to, xanthan gum, guar gum, konjac flour and locust bean gum. Examples of suitable stabilizers include chondrus extract (carrageenan), pectin, gelatin, and agar. Blends of Xanthan Gum, Locust Bean Gum and Guar Gum are commonly used in the production of cheese analogues.

Acidulants are additives that give a sharp taste to foods by increasing the tartness or acidity. They also assist in the setting of gels and to act as preservatives. An acidulant (acidic agent) can be incorporated to adjust the pH of the finished cheese to a desired level. In combination with emulsifying salts, the acidulants in the dry blend will help maintain the pH at the desired level. Natural acidifiers such as lemon juice or apple juice may also be used. The titratable acidity and pH of the cheese can be controlled to help regulate the melt down characteristics of the finished cheese. Various acids can be employed at the end of the cooking process; examples of suitable acids include, but are not limited to, acetic acid, citric acid, fumaric acid, lactic acid, malic acid, phosphoric acid, tartaric acid adipic acid, hydrochloric acid, glucano delta lactone, lactobionic acid or Genlac C, the latter being a blend of water, citric acid, lactic acid, and acetic acid. Acid is typically added to adjust the pH of the finished cheese to a pH from about 4.8-6.5 is reached.

A colorant can be incorporated into the soft or firm/semi-hard ripened or unripened blended cheese to adjust its natural color. This can be useful, for example, if consumers have a preference for a color other than the naturally-occurring color. Examples of suitable colorants include annatto, turmeric, titanium dioxide, and beta-carotene. Colorants may be of both the natural or artificial color. If one wished to color the cheese a red, an artificial color such as FD&C red #40 can be used. Annatto imparts a yellowish color to cheese. The yellowish color often is preferred by consumers who perceive it to indicate a “richer” product upon cooking on a pizza. Colorants can be incorporated into the final soft or firm/semi-hard ripened or unripened blended cheese product by inclusion in the slurry. If added at the mixing stage, the colorant is generally sprayed onto the heated cheese mass as an unheated solution or dispersion in water. The amount of colorant added is typically in the range of about 0.01 to 0.02%, based on the weight of the finished cheese. Turmeric, if used, is generally added in an amount of about 0.01 to 0.001%. If annatto is added, it normally is added to about 0.1 to 0.2% by weight. Various flavoring agents can also be incorporated into the cheese to tailor the flavor profile of the cheese to meet consumer preferences. Suitable flavors for mixing into the heated cheese include, for example, natural mozzarella flavor such as diacetyl and/or lipolyzed fat, or enzyme modified cheese for cheddar cheese. Flavoring agents can be incorporated into the final soft or firm/semi-hard ripened or unripened blended cheese product by incorporation into the heated slurry or by addition to the heated cheese mass as a dry powder, or more typically as part of an unheated aqueous solution. Flavoring agents are typically added in an amount such that the concentration in the final cheese product is within the range of about 0.01 to 5 wt. %. If incorporated into the slurry, the concentration of the flavoring agent in the slurry is generally is in the range of about 0.11-4.50 wt. %.

The cheese of the present invention can be a semi-hard cheese or a semi-hard, reduced (or low) fat cheese. A semi-hard cheese according to the invention can have a fat (or oil) content of between 18 and 35 wt. % whereas a low fat cheese can have a fat content of between 6 and 17 wt. %. For both cheese, the amounts of starch and protein may vary. In embodiments aimed at the semi-hard cheese of the invention, the combined amount of starch and protein is between 15 and 40 wt. %, with protein % ranging from 0 to 20 wt. %. The preferred amount of lecithin is as outlined above.

For the semi-hard low fat cheese, the combined amount of starch and protein is between 20 and 45 wt. %, with protein % ranging from 0 to 20 wt. %. The preferred amount of lecithin is as outlined above.

Semi-hard cheese can be made with varying protein concentrations.

| | Min-Max | Min-Max | Min-Max | Min-Max |
|---|---|---|---|---|
| | wt. % | wt. % | wt. % | wt. % |
| Protein | 0 | 5 | 10 | 20 |
| Oil | 18-35 | 18-35 | 18-35 | 18-35 |
| Starch | 15-40 | 10-35 | 5-30 | 1-20 |
| Lecithin | 1-5 | 1-5 | 1-5 | 1-5 |
| Water | Up to | Up to | Up to | Up to |
| | 100 | 100 | 100 | 100 |
| Protein + | 15-40 | 15-40 | 15-40 | 15-40 |
| starch | | | | |

Semi-hard low fat cheese can be made with varying protein concentrations:

| | Min-Max | Min-Max | Min-Max | Min-Max |
|---|---|---|---|---|
| | wt. % | wt. % | wt. % | wt. % |
| Protein | 0 | 5 | 10 | 20 |
| Oil | 6-17 | 6-17 | 6-17 | 6-17 |
| Starch | 20-45 | 15-40 | 10-35 | 1-25 |
| Lecithin | 1-5 | 1-5 | 1-5 | 1-5 |
| Water | Up to | Up to | Up to | Up to |
| | 100 | 100 | 100 | 100 |
| Protein + | 20-45 | 20-45 | 20-45 | 20-45 |
| starch | | | | |

In a further aspect of the invention, it pertains to a method of preparing a plant-based cheese analogue composition comprising the steps of:
mixing starches, optional proteins, lecithin, fat and water
providing a homogenous mixture from the mixed ingredients by mixing under shear to form an emulsion;

providing a plant-based cheese analogue.

In a particular preferred embodiment, the semi-hard (low fat) plant-based cheese of the invention comprises

| | Semi-hard | | Semi-hard, low fat | |
|---|---|---|---|---|
| Min-Max (wt. %) | | preferred | | preferred |
| coconut oil | 18-35 | 20-30 | 6-17 | 9-14 |
| plant protein | 0-11 | 4-9 | 0-11 | 4-9 |
| (lentil and/or pea) | | | | |
| potato starch | 6-8 | 6-8 | 6-8 | 6-8 |
| modified tapioca starch | 8-12 | 8-12 | 8-12 | 8-12 |
| modified potato starch | 5-6 | 5-6 | 5-6 | 5-6 |
| modified waxy corn starch | 5-6 | 5-6 | 5-6 | 5-6 |
| lecithin (sunflower | 0.2-5 | 3-5 | 0.2-5 | 3-5 |
| and/or soybean) | | | | |
| Water | up to | up to | up to | up to |
| | 100% | 100% | 100% | 100% |

The process of the invention can be performed in a variety of ways that have an effect on the structure, texture and mouthfeel of the product. In certain embodiments, in the mixing step, the dry ingredients are suspended or dissolved in water followed by the addition of fat. In preferred embodiments, the addition of fat is under shear until a homogenous mixture is obtained. In other embodiments, in the mixing step, a pre-mix is made from the dry ingredients, followed by the addition of fat and water. In preferred embodiments, the addition of fat and water is under shear until a homogenous mixture is obtained. In certain embodiments, the addition of adding fat is under shear until a homogenous mixture is obtained. In certain embodiments, in the mixing step, the dry ingredients are combined with fat, followed by the addition of water. In certain embodiments, the addition of fat followed by the addition of water is under shear until a homogenous mixture is obtained.

The pH of the water or the homogenous mixture can be adjusted to between 5 and 8, preferably between 5.5 and 7, more preferably between 4.8 and 6.5.

The method can compromise a step of heating the water, the fat and/or the emulsion to a temperature ranging from 20 to 85 degrees centigrade, preferably between 50 and 70 degrees centigrade.

The method may further comprise a step of comprising cooling the homogenised emulsion to a temperature ranging from 0 to 20 degrees centigrade, preferable between 2 and 10 degrees centigrade. This allows the product to settle and become firm. The cooling process may also be useful for forming the product, i.e. mould it into a desired shape.

In preferred embodiments, the emulsifier can be added at any process stage prior final mixing and product filling. However, in certain emulsions, the addition of lecithin in the first process step has been found to have a positive contribution to emulsion stability. Furthermore, the addition of lecithin in the first step allows for a shorter processing time.

Thus, in preferred embodiments, the dry ingredients including lecithin are mixed to from a pre-mix. To the premix, fat is added under shears, followed by the addition of water under shear. Alternative, water is added to the premix under shear, followed by the addition of oil.

The resulting cheese expressed a lower exudation and an improve mouthfeel over cheese in which the ingredients were all combined and subsequently mixed under shear.

### EXAMPLES

Lecithin (Bolec and Sunlec, Native, hydrolysed and PC-enriched) was obtained from Sime Darby, Zwijndrecht, the Netherlands and used as-is, containing about 35% oil.

### Example A Direct Blending

The plant-based cheese analogue is made by mixing water, proteins, starches, lecithin, oil and other ingredients in a blender, such as a high shear mixer, typically a Thermomixer, at a medium speed and for about 1 minute at a temperature below pasteurization, followed by mixing under high shear, typically at 50-70 degrees Celsius (pasteurization temperature) until a homogenous mass is obtained, typically after 5-10 minutes. Viscosity is noticeably increased. The mixture was allowed to cool to 4 degrees Celsius and set for two days.

Product parameters such as viscosity and hot and cold and elasticity are determined using standard procedures.

### Example B Pre-Blending of an Aqueous Phase

The process is identical to Example A, but the plant-based cheese analogue is made by first mixing water, proteins, starches, lecithin and other water soluble ingredients in a blender at medium speed and subsequently oil is mixed in and the mixture blended under high shear at pasteurisation temperature for an additional 10 minutes. The mixture was allowed to cool to 4 degrees Celsius and set for two days.

### Example C Pre-Blending of Dry Ingredients and Water

The process is identical to Example A, but the plant-based cheese analogue is made by mixing proteins, starches, lecithin and other dry soluble ingredients, followed by the addition of water in a blender, typically a Thermomixer, at a medium speed and mixed at 50-70 degrees Celsius until a homogenous mass is obtained, typically after 5-10 minutes. Subsequently, oil is mixed in and the mixture blended for an additional 10 minutes. The mixture was allowed to cool to 4 degrees Celsius and set for two days.

### Example D Pre-Blending of Dry Ingredients and Oil

The process is identical to Example A, but the plant-based cheese analogue is made by mixing proteins, starches, lecithin and other dry soluble ingredients, followed by the addition of fat in a blender, typically a Thermomixer, at a medium speed and mixed at 50-70 degrees Celsius until a homogenous mass is obtained, typically after 5-10 minutes. Subsequently, water is mixed in and the mixture blended for an additional 10 minutes. The mixture was allowed to cool to 4 degrees Celsius and set for two days.

### Example G

A variety of preparations were made as described in Table 1:

| Parts by weight | | | | | | | |
|---|---|---|---|---|---|---|---|
| (W/W) | Ex. 3 | Ex. 4 | Ex. 5 | Ex. 6 | Ex. 7 | Ex. 8 | Ex. 9 |
| Water | 44 | 44 | 44 | 44 | 44 | 44 | 41 |
| coconut oil | 23 | 23 | 23 | 23 | 23 | 23 | 12 |
| plant protein | 0 | 5 | 5 | 7 | 5 | 5 | 7 |
| (lentil and/or pea) | | | | | | | |
| modified tapioca | 9.2 | 9.2 | 9.2 | 9.2 | 9.2 | 9.2 | 11 |
| starch | | | | | | | |
| modified potato starch | 9.5 | 9.5 | 9.5 | 9.5 | 9.5 | 9.5 | 11 |
| modified corn starch | 7 | 7 | 7 | 7 | 7 | 7 | 8 |
| lecithin | 1 | 2 | 4 | 1 | 1 | 0 | 3 |
| (Bolec, Sunlec) | | | | | | | |
| colorant (diluted) | 0.72 | 0.72 | 0.72 | 0.72 | 0.72 | 0.72 | 0.72 |
| Flavor | 0.46 | 0.46 | 0.46 | 0.46 | 0.46 | 0.46 | 0.46 |
| Salt | 2.24 | 2.24 | 2.24 | 2.24 | 2.24 | 2.24 | 2.24 |
| calcium salt | 1 | 1 | 1 | 1 | 1 | 1 | 1 |
| Acidifier | 2 | 2 | 2 | 2 | 2 | 2 | 2 |

Control product 1 Dairy cheese, (4-6 weeks matured) was obtained from a local shop (Albert Heijn, Rotterdam)

Control product 2 Plant-based cheese (gouda type, 21% coconut and 12% total starch content) was obtained from a local shop (Albert Heijn, Rotterdam)

### Testing

The cheeses were tested by a trained panel (panel size 10) using a quantitative description analysis that delivers a complete profile of each cheese or cheese substitute covering all sensory dimensions by using a specifically discussed and commonly understood list of attributes developed by the panel. For training of the panel suitable aroma or other flavour references are used. A control product can be used as calibration. Then the evaluation of the test products takes place in reference to the control product. Two to three assessments per product are made. A bite is taken from the product and the relevant parameter is assessed comparatively (higher lower than a control product)

| # | Attribution | Range | description |
|---|---|---|---|
| 40 | Dryness | (0-5) | Measure of how dry the |
| | | | product feels in the mouth |
| | | | 0 = very dry; |
| | | | 5 = very wet |
| 42 | Lumpiness | (0-5) | Measure of how chewy the |
| | | | product is while chewing |
| | | | 0 = not chewy; |
| | | | 5 = very chewy |
| 44 | Melting | (0-5) | Measure of how fast the |
| | behaviour | | product dissolves in |
| | | | the mouth |
| | | | 0 = no melt; |
| | | | 5 = quick melt |
| 39 | Sticky | (0-5) | Measure of how much the |
| | | | product provide a film |
| | | | in the mouth (melting) |
| | | | 0 = not sticky; |
| | | | 5 = very sticky |
| 41 | powdery | (0-5) | Measure of how powdery |
| | | | the product feels |
| | | | in the mouth |
| | | | 0 = not powdery; |
| | | | 5 = very powdery |

### Results:

| | | | | | |
|---|---|---|---|---|---|
| # | 40 | 42 | 44 | 39 | 41 |
| Attribution | Dry | Lumpy | Melting | Sticky | Powdery |

| | | | |
|---|---|---|---|
| Comp. Ex. 1 | 5 | 5 | 5 |
| Dairy cheese | | | |
| Comp. Ex. 2 | 1 | 2 | 4-5 |
| Plant-based cheese | | | |
| Ex. 3 | 4 | 3 | 3 |
| Ex. 4 | 4 | 4 | 4 |
| Ex. 5 | 5 | 4 | 5 |
| Ex. 6 | 3 | 3 | 4 |
| Ex. 7 | 4 | 3 | 4 |
| Ex. 8 | 1 | 2 | 2 |
| Ex. 9 (low fat) | 3 | 3 | 3 |

Plant-based cheese with 4% native lecithin was found to be the closest resemblance to dairy cheese. Hydrolysed lecithins were tested (HLB >7), both Bolec and Sunlec, using the recipe of example 5, but did not lead to acceptable cheese products. PC-depleted lecithin was tested (HLB <7), both Bolec and Sunlec, using the recipe of example 5, and provided acceptable cheese products.

### Stability Testing

Stability testing of the cheeses of examples 3-9 was performed under conventional cycling conditions. The cheeses were found to be stable, no exudation of oil or water was observed. The presence of plant proteins is found to aid in the stability of the cheese.

1. A plant-based cheese of the half-hard type, comprising
5-35 wt. % of a vegetable fat;
1-45 wt. % starches and/or modified starches;
1-7 wt. % of a lecithin selected from the group consisting of soy lecithin, sunflower lecithin, cottonseed lecithin, rape seed lecithin, and any combination thereof;
the remainder up to 100 wt. % being water, wherein the wt. % are calculated on the total composition.

2. The plant-based cheese according to claim 1, wherein the vegetable fat is coconut fat.

3. The plant-based cheese according to claim 1, wherein the amount of lecithin is between 2 wt. % and 6 wt. %.

4. The plant-based cheese according to claim 1, wherein the starches are selected from the group consisting of modified and unmodified starches.

5. The plant-based cheese according to claim 1, wherein the starches are selected from the group consisting of wheat starch, corn starch, potato starch, rice starch, tapioca starch, and any combination thereof.

6. The plant-based cheese according to claim 1, further comprising a plant protein, plant protein isolate or plant protein concentrate present in an amount from 0.1 to 20 wt. %.

7. The plant-based cheese according to claim 1, wherein the plant protein in the plant protein, plant protein isolate or plant protein concentrate is selected from the group consisting of lentil protein, fava (Vicia faba) protein, pea protein, or combinations thereof.

8. The plant-based cheese according to claim 1, wherein the vegetable fat is a non-hydrogenated fat and/or does not contain palm-oil of palm-oil derived fats or fractions thereof.

9. A method of preparing a plant-based cheese analogue composition comprising the steps of:
mixing starches, optional proteins, a lecithin selected from the group consisting of soy lecithin, sunflower lecithin, cottonseed lecithin, rape seed lecithin, and combinations thereof, fat and water;
providing a homogenous mixture from the mixed ingredients by mixing under shear to form an emulsion; and
providing a plant-based cheese analogue.

10. The method according to claim 9, wherein in the mixing step, the dry ingredients are suspended or dissolved in water followed by the addition of fat.

11. The method according to claim 9, wherein the addition of fat is under shear until a homogenous mixture is obtained.

12. The method according to claim 9, wherein in the mixing step, a pre-mix is made from the dry ingredients, followed by the addition of fat and water.

13. The method according to claim 9, comprising forming the plant-based cheese.

14. The plant-based cheese according to claim 1, wherein the lecithin is a fractioned lecithin.

15. The plant-based cheese according to claim 1, wherein the amount of lecithin is between 3 wt. % and 4.5 wt. %.

16. The plant-based cheese according to claim 1, wherein the starches are modified starches.

17. The method according to claim 9, wherein the lecithin is a fractioned lecithin.
